(19) United States
(12) Patent Application Publication
(10) Pub. No.: US 2024/0075825 A1
(43) Pub. Date: Mar. 7, 2024

(54) Vehicle Charge Station Adapter

(71) Applicant: Colin Patrick Wales, Delhi (CA)

(72) Inventor: Colin Patrick Wales, Delhi (CA)

(21) Appl. No.: 17/822,143

(22) Filed: Aug. 25, 2022

(51) Int. Cl. B60L 53/16; H01R 31/06

(52) U.S. Cl. CPC B60L 53/16; H01R 31/065; B60L 2200/24

(57) ABSTRACT

Electric vehicle supply equipment adapter, that enables the charging of much smaller, personal electric vehicles, that normally require an ordinary wall outlet.

### BACKGROUND

### Technical Field

The present invention is in the technical field of power delivery. More particularly, the present invention is in the technical field of converting one power plug type to another power plug type. More particularly, the present invention is in the technical field of connecting vehicle charging plugs and standardized AC or DC connectors, all of which vary, from one country to another.

### Prior Art

Many electric vehicle charging stations are already in use. Such a station, is commonly known as an Electric Vehicle Supply Equipment (EVSE) among known patents. The guidelines for these vehicle charging stations have been released by the Society of Automotive Engineers (SAE). These vehicle charging stations are commonly available to the public. However, these charge stations have connectors that only fit the charging ports of electric cars and trucks. Vehicle charge stations, by design, will not allow high voltage power to reach the connector unless it detects a vehicle at the other end. These properties, make them incompatible with smaller electric vehicles and devices. Current adapter technology is bulky and lacks the availability of compact size options. Current adapter technology is also prohibitive to build because of cost and complexity.

### CITATIONS

| | | |
|---|---|---|
| U.S. Pat. No. 5,369,352A | Universal electric vehicle charging adapter | 1993 Apr. 26 |
| JPH077860A | UNIVERSAL ELECTRIC MOTORCAR | 1993 Apr. 26 |
| | CHARGING ADAPTOR | |
| JPH0737644A | CONNECTOR FOR CHARGING ELECTRIC | 1993 Jul. 22 |
| | VEHICLE | |
| U.S. Pat. No. 6,358,096B1 | Multiple source power adapter for output power | 2000 Dec. 29 |
| | control | |
| U.S. Pat. No. 6,937,490B2 | Dual input AC and DC power supply having a | 2001 Oct. 31 |
| | programmable DC output utilizing a secondary | |
| | buck converter | |
| U.S. Pat. No. 6,972,975B2 | Voltage converter with selectable output voltage | 2003 Jun. 23 |
| | levels. | |
| U.S. Pat. No. 7,422,473B2 | Power adapter cable with commonly configured | 2005 Nov. 1 |
| | interfaces | |
| U.S. Pat. No. 7,642,671B2 | POWER SUPPLY SYSTEM | 2006 Apr. 28 |
| U.S. Pat. No. 8,030,882B2 | POWER SUPPLY UNIT | 2007 Jun. 15 |
| WO2009034883A1 | CHARGE SYSTEM FAILURE JUDGING | 2007 Sep. 10 |
| | DEVICE AND FAILURE JUDGING METHOD | |
| US2011300753A1 | PLUG CONVERSION ADAPTOR | 2011 Dec. 8 |
| DE102011007763A1 | Adapter cable for converting first type terminal | 2012 Oct. 25 |
| | into second type terminal at charging cable used | |
| | for charging electric energy storage of e.g. | |
| | electric vehicle, has latching units for locking | |
| | connection among connectors and terminals | |
| US2015175023A1 | ELECTRIC VEHICLE AC POWER ADAPTER | 2015 Jun. 25 |
| US2017250550A1 | STANDALONE ADAPTER FOR LOAD | 2016 Feb. 31 |
| | CONTROL OF ENERGY STORAGE DEVICES | |
| WO2017151819A1 | INTERCONNECT SOCKET ADAPTER FOR | 2016 Mar. 1 |
| | ADAPTING ONE OR MORE POWER SOURCES | |
| | AND POWER SINKS | |
| US2016276787A1(B2) | RECEPTACLE ASSEMBLY OF NEMA PLUGS | 2016 Sep. 22 |
| US2019283616A1 | SYSTEMS AND METHODS FOR PAIRING IN | 2018 Mar. 19 |
| | WIRELESS ENERGY TRANSFER NETWORKS | |
| U.S. Ser. No. 10/230,198B2 | EVSE energy management system retrofit coupling | 2019 Mar. 12 |
| Non patent citation: | SAE Surface Vehicle Recommended Practice J1772 | |

### SUMMARY

The present invention is an adapter that allows users to deliver power to smaller, personal electric vehicles, including, but not limited to, e-bikes, seniors' mobility scooters, electric road scooters, small folding portable electric scooters, electric skateboards, “one wheel” skateboards, Segways, electric unicycles, hover-boards, and many other devices that depend on ordinary wall outlets or alternative connectors to deliver power.

### BRIEF DESCRIPTION OF DRAWINGS

FIG. 1 is an external perspective view, of a possible form, of the present invention.

FIG. 2 is another external perspective view, of a possible form, of the present invention.

FIG. 3 is another external perspective view, of a possible form, of the present invention.

FIG. 4 is a side view, demonstrating a possible use for present invention.

FIG. 5 shows a Simulation Program with Integrated Circuit Emphasis (SPICE). The invention is shown connected to a simplified vehicle charging station, to demonstrate how they co-operate with each other.

FIG. 6 is a graph of the voltage on the vehicle charge station's Control Pilot line when in the “B” state.

FIG. 7 is a graph of the voltage on the vehicle charge station's Control Pilot line when in the “C” state.

FIG. 8 is a flow chart. It illustrates the back and forth, sequence of events that happen between the present invention, and a vehicle charging station.

FIG. 9 shows a simpler alternative circuit, with one external, low voltage control switch.

FIG. 10 shows a simpler alternative circuit, with no external control switch.

FIG. 11 shows a simpler alternative circuit, with fused protection.

FIG. 12 shows a simpler alternative circuit, with a higher voltage external cut off switch, on the power line.

FIG. 13 shows a simpler alternative circuit, using an internal AC to AC or AC to DC converter.

FIG. 14 shows a simpler alternative circuit, using an external AC to AC or AC to DC converter.

### DETAILED DESCRIPTION OF THE INVENTION

Although, most of the drawings contained in this disclosure show Nema-5 15R compatible and a truncated SAE J1772 compatible vehicle-side compatible connectors, they serve as an example only. Other types of connectors or multiple connectors may be used in addition to or in substitution to the connectors shown as well as any extension cord(s) (118) that may protrude from the body (12) of the present invention, or, any extension cord(s) (118), that are used in any detachable form. Any of these extension cord(s) (118) may terminate in other types of connectors or multiple connectors.

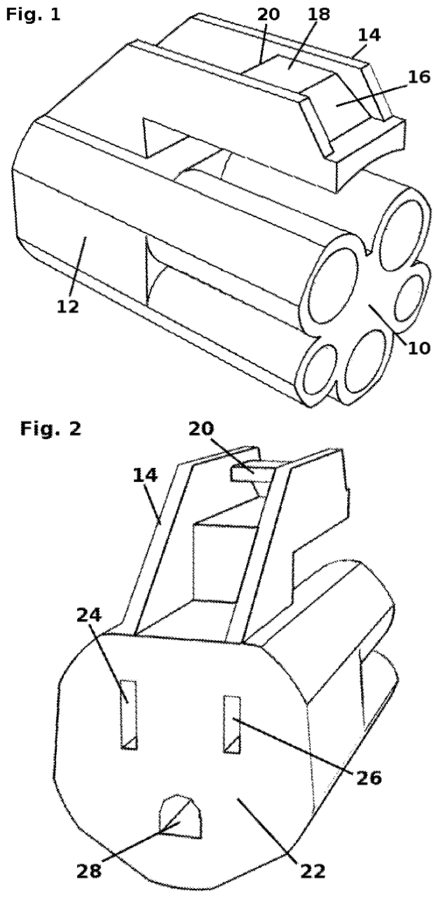

Referring now, to the invention, in more detail, in FIG. 1 the first feature in the present invention, is the compact nature. This gives it the ability to carry it around in an ordinary pocket on any item of clothing. Considerable effort was given in truncating the vehicle side charge connector (10), in order to achieve this degree of compactness and portability. A larger, full size vehicle connector on this invention, or any competing invention, may cause such a device to be unfit for use, due to the inconvenience of not being small enough to easily carry on one's person. FIGS. 1,2,3, and 4 all make the size of the invention apparent, when, the proportion to the connectors is revealed.

In more detail, still referring to the present invention in, FIG. 1 shows a vehicle side charge connector (10). Furthermore, a partial view, of one side of the present invention's body (12) can be seen. This drawing also reveals some details, of a proposed anchor point, or retaining clip (14), protruding from the body (12) of the present invention. The job of this clip (14), is to provide a locking surface, for the charge station side connector (42) to grab, and hold the present invention in place. When the vehicle side charge connector(10) and charge station side connector (42) are slid together, a pivoting latch (44), on the charge station side connector (42), slides up a ramp (16), then, over a plateau (18). Finally, the pivoting latch (44) travels past the edge of the plateau (18) and locks into place on the back edge (20)

Referring now, to the invention in FIG. 2, in further detail, the retaining clip (14) can be viewed from the other side, with a better view of the back edge of the plateau (20). Furthermore, this side shows an example of a wall outlet (22). The particular version in the image is a Nema 5-15R. However, this may be different, depending on region. The drawing of this particular outlet shows the holes for white/neutral (24), black/hot (26), and green/ground (28).

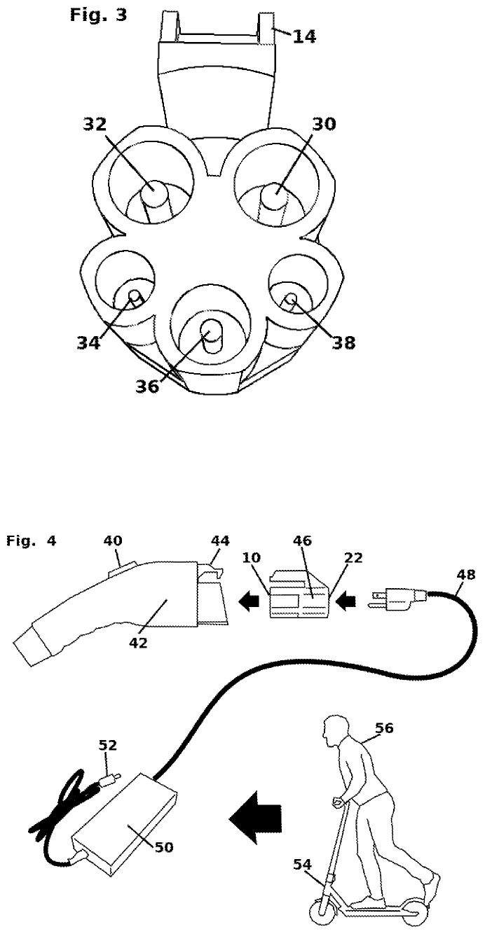

Referring now, to the invention in FIG. 3, in further detail, is a more direct, perspective view of the vehicle side charge connector (10). This side shows further detail of the pins for L1 pin (30), L2 pin(32), Control Pilot pin(34), Chassis Ground (36), Proximity Detection pin (38), as well as the underside of the retaining clip (14).

Referring now, to FIG. 4, in further detail, presents an example, in overview, of a possible implementation of the present invention. The user (56), presses a button (40) on the top of the charger side connector (42), raising the pivoting latch (44). The charge station side connector (42), joins up with the present invention, shown in side view (46). The opposite end of the invention, in this example, is a wall outlet (22). The present invention has now broadened the usefulness of the vehicle charge station. The user (56), can, in this example, plug in an extension cord (48), to power an external AC to AC and or AC frequency to another AC frequency or AC to DC converter (50). The external power connectors (52) can then, be used to recharge a small personal electric vehicle (54) or other device. Without the present invention, an electric vehicle charging station, would normally not be able to recharge a vehicle of this type, or power any other device this small.

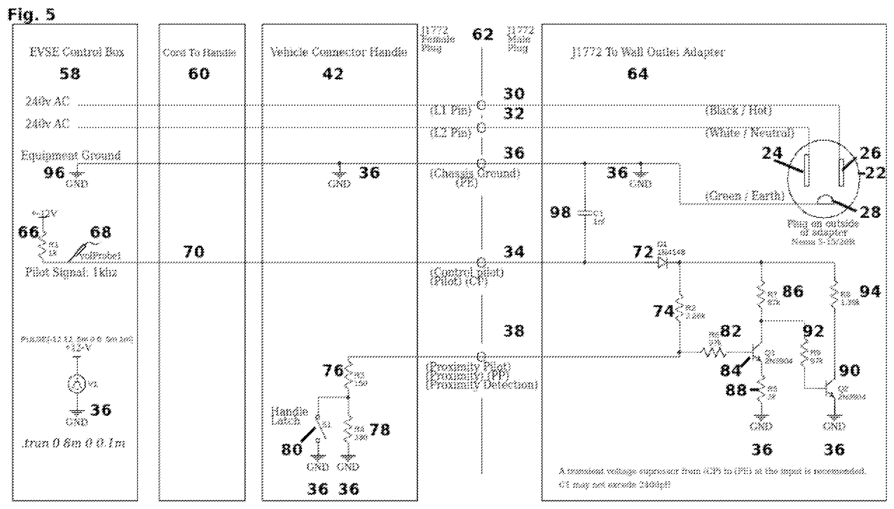

Referring now, to FIG. 5, in further detail, a circuit, ready for simulation, is shown. FIG. 5 contains a vastly simplified version of an electric vehicle charging station (58), and the vehicle charging station's power cord (60), a charge station side connector (42), and one example circuit of the present invention (64). the broken line, down the middle of the circuit, represents the temporary mechanical connection (62) between the charge station side connector (42), and the vehicle side charging connector (10) on the present invention.

In more detail, still referring to the circuit in FIG. 5, the operation of the circuit works as follows. A positive and negative 12 Volt square wave signal is passed through a 1 k resistor (66), followed by a voltage monitoring unit (68) on a signal line (70) inside the electric vehicle charging station (58). The signal line (70) continues down the cord (60), through the charge station side connector (42), into the vehicle side charge connector (10), on the Control Pilot pin (34). The signal continues through a diode (72) and a 2.26 k ohm resistor (74). The signal is passed back to charge station side connector (42), through the Proximity Detection pin (38), and two more resistors: 150 ohms (76) and 330 ohms (78). Finally, the signal reaches Chassis Ground (36) inside the charge station side connector (42). When connected, the voltage monitoring unit (68) inside the electric vehicle charging station (58) will measure+9 Volts on the positive side of the square wave. This is because the series of resistors (66, 74, 76, 78) form a voltage divider. It only affects the positive side of wave, because of the diode (72). At this point, the electric vehicle charging station (58) is in “State B”. This means: “vehicle connected, but still waiting for a charge” according to the Society of Automotive Engineers (SAE) guidelines.

In more detail, still referring to the circuit in FIG. 5, the user (56), releases the button (40) on the charge station side connector (42), locking the pivoting latch (44) on the retaining clip (14). The release of this button(40) closes a switch (80) inside the charge station side connector (42). The switch (80), allows the signal to bypass the 330 ohm (78) resistor, lowering the voltage on the Proximity Detection pin (38), This drop in voltage is sensed by the base of the first transistor (84) through a 97 k ohm (82) current limiting resistor. The transistor (84), is biased by another 97 k ohm (86) and a 3 k ohm (88) resistor. The drop in voltage on the Proximity Detection pin (38), turns off the first transistor (84), driving the voltage on first transistor's (84) collector high. The collector on first transistor (84) is connected to the base of the second transistor (90), through another 97 k ohm (92) current limiting resistor. The second transistor (90) is now turned on, allowing current through a 1.39 k ohm (94) resistor. The 1.39K ohm (94) resistor is now in parallel with the series of resistors (74, 76, 78). This further drops the voltage on the signal line (70) and the voltage monitoring unit (68) will now measure+6 Volts on the positive side of the square wave. At this point, the electric vehicle charging station (58) is in “State C”. This means: “vehicle connected, ready to accept energy” in the Society of Automotive Engineers (SAE) guidelines. When the electric vehicle charging station (58) is in “State C” it closes an internal relay (not shown) that connects L1 pin (30) and L2 pin (32) to the electrical grid. Inside the present invention, in this example, the L1 pin (30) is connected to black/hot (26), the L2 pin (32) is connected to white/neutral (24), and Chassis Ground (36) is connected to green/ground (28). Inside the electric vehicle charging station (58), Chassis Ground (36) is connected to equipment ground (96). Electrical power is now available at the present invention's example of a wall outlet (22). A 1 nano-farad (98) capacitor is connected between the Control Pilot pin (34) and the Chassis Ground (36), ahead of any other components, to help protect these sensitive components from transient voltages. Many transient voltage suppression techniques exist, and may be substituted. This is only an example. The 1 nano-farad (98) capacitor may even be substituted with other values, as long as it does not exceed 2.4 nano-farad, according to the Society of Automotive Engineers (SAE) guidelines. Many of the resistor values in this description are also just suggestions, and may also be substituted.

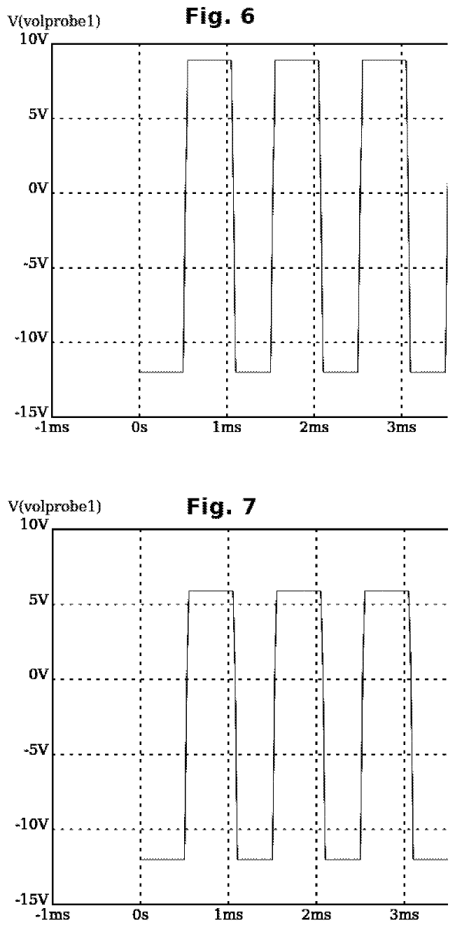

Referring now to the graph, FIG. 6, in further detail, a Simulation Program with Integrated Circuit Emphasis (SPICE) depicts what the voltage monitoring unit (68) inside the electric vehicle charging station (58) will be detecting, when in state “B”. The graph shows voltage plotted over time. The peak of the wave is at +9 volts and the bottom of the wave is at −12 volts. The frequency of the signal is 1 khz, however, the duty cycle of the signal will vary depending on the amount of current available from the electric vehicle charging station (58)

Referring now to the graph, FIG. 7, in further detail, the Simulation Program with Integrated Circuit Emphasis (SPICE) depicts what the voltage monitoring unit (68) inside the electric vehicle charging station (58) will be detecting, when in state “C”. The graph shows voltage plotted over time. The peak of the wave is at +6 volts and the bottom of the wave is at −12 volts. The frequency of the signal is 1 khz, however, the duty cycle of the signal will vary depending on the amount of current available from the electric vehicle charging station (58)

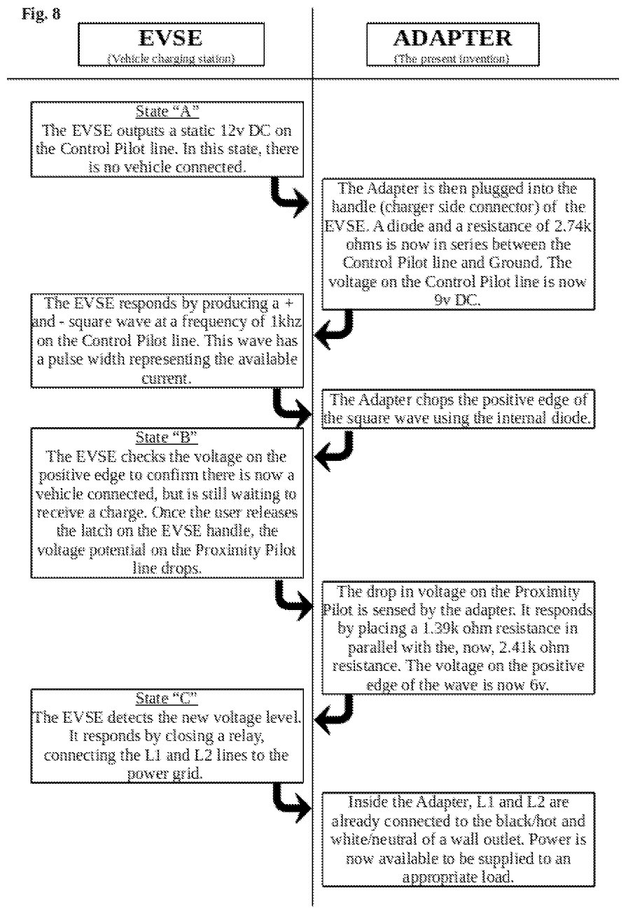

Referring now to the flow chart, in FIG. 8, in further detail, the page is split in half. The items that appear on the left side of the page are events that occur inside the electric vehicle charging station (58), normally referred to as: electric vehicle supply equipment (EVSE) by Society of Automotive Engineers (SAE). The events that appear on the right side of the page, are events that happen inside the present invention. In this flow chart the present invention will be referred to as “Adapter”.

In more detail, still referring to the flow chart in FIG. 8, the events described in each box generally flow chronologically from top to bottom. Each step triggers the next event in a back and forth sequence, that results in power being made available at the present invention's example of a wall outlet (22).

When being connected, the present invention, will cause the electric vehicle charging station (58) to transition from State “A” to State “B”, then State “C”. However, when disconnecting the present invention from the charge station side connector (42), the order is reversed. The electric vehicle charging station (58) will go from State “C” to State “B”, then State “A”.

Referring now, to the present invention in FIG. 9, in further detail, is a much simpler variation. In this variation, a single 2.74 k ohm (100) resistor is used instead of the series of resistors (74, 76, 78). The single 2.74 k ohm (100) resistor is connected directly to Chassis Ground (36) inside of the present invention, instead of using Proximity Detection pin (38). This is enough for the electric vehicle charging station (58) to go into State “B”. However, since this variation doesn't use the switch (80) inside the charge station side connector (42), it will require it's own switch (102) mounted on the outside of the present invention's body (12). This switch (102), is wired in series with a 1.3 k ohm (104) resistor. When the switch (102) is closed, the 1.3 k ohm (104) resistor is in parallel with the 2.74 k ohm (100), this will now cause the electric vehicle charging station (58) to go into the desired State “C”.

Referring now, to the present invention in FIG. 10 in further detail, is an even simpler version than the one in FIG. 9. In this version, a single 880 ohm (106) resistor replaces all other resistors and replaces the switch (102) from the previous example. This version of the present invention, is only capable of remaining in State “C”. It does not support State “B”.

Referring now, to the present invention in FIG. 11 in further detail, is a copy of the basic version from FIG. 10, but with a fuse (108) and or breaker on the L1 pin (30) and or L2 pin (32), to provide an extra layer of over current protection. This feature is not limited to the basic version of the current invention. It may occur in combination with any of the other circuits or features of the present invention.

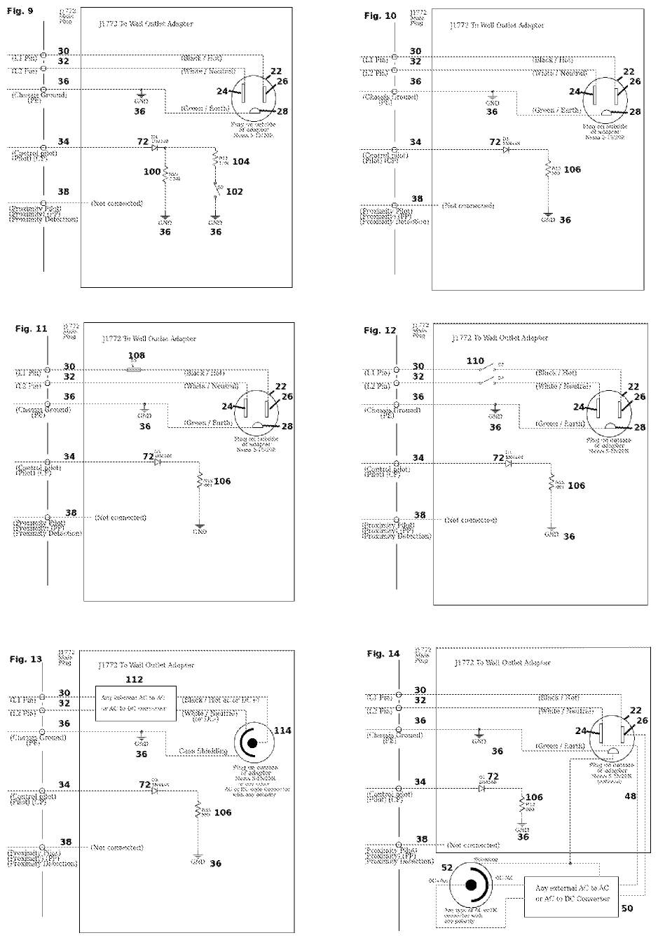

Referring now, to the present invention in FIG. 12 in further detail, is a copy of the basic version from FIG. 10, but with one or more switch(s) (110) on the L1 pin (30) and or L2 pin (32), to provide a means for turning on and shutting off power to the example of a wall outlet (22). This feature is not limited to the basic version of the current invention. It may occur in combination with any of the other circuits or features of the present invention.

Referring now, to the present invention in FIG. 13 in further detail, is a copy of the basic version from FIG. 10, but with an internal AC to AC and or AC frequency to another AC frequency or AC to DC converter (112) on the L1 pin (30) and L2 pin (32), to provide a means of creating an appropriate output for a desired electrical load. This feature is not limited to the basic version of the current invention. It may occur in combination with any of the other circuits or features of the present invention. This is a prime example of why the present invention is not limited to just providing wall outlets (22). Any variation or combination of power connectors (114) or wall outlets (22) on the body (12) of the present invention, or, extension cord(s) (48) that terminate in any variation or combination of external power connectors (52) or combination of wall outlets (22) might be used.

Referring now, to the present invention in FIG. 14 in further detail, is a copy of the basic version from FIG. 10, but with an external AC to AC and or AC frequency to another AC frequency or AC to DC converter (50) connected indirectly through any variation or combination of external power connectors (52) or combination of wall outlets (22) or, extension cord(s) (48) that terminate in any variation or combination of external power connectors (52) or combination of wall outlets (22), to the L1 pin (30) and L2 pin (32), to provide a means of creating an appropriate output for a desired electrical load. This feature is not limited to the basic version of the present invention. It may occur in combination with any of the other circuits or features of the present invention. This is another prime example of why the present invention is not limited to just providing wall outlets (22). Any variation or combination of power connectors (52), or wall outlets (22), outside the body (12) of the present invention, or, extension cord(s) (48) that terminate in any variation or combination of external power connectors (52), or combination of wall outlets (22), that might be used.

Lastly, an internal or external feature or mechanism (not shown) for locking the present invention to the charge station side connector (42), and or internal or external feature or mechanism, for locking the present invention to any extension cord (48), and or internal or external feature or mechanism (not shown) for attaching a chain, padlock, or bicycle lock, as a means to deter theft or tampering, while left unattended.

1. An adapter that consists of a vehicle inlet connector for electric vehicle supply equipment (EVSE).

2. The adapter of claim 1 further consisting of one or more output power connectors of any type.

3. The adapter of claim 1 further consisting of an analog circuit connected to said adapter's pilot signal input.

4. The adapter of claim 1 further consisting of an embodiment that is portable.
